(19) United States
(12) Patent Application Publication
(10) Pub. No.: US 2015/0081323 A1
(43) Pub. Date: Mar. 19, 2015

(54) SYSTEMS AND METHODS FOR DISEASE KNOWLEDGE MODELING AND CLINICAL DECISION SUPPORT

(71) Applicant: Molecular Health GmbH, Heidelberg (DE)

(72) Inventors: David B. Jackson, Heidelberg (DE); Alexander Zien, Heidelberg (DE); Stephan Brock, Weinheim (DE); Alexander Picker, Heidelberg (DE); Guillaume Taglang, Heidelberg (DE); Bernhard Sulzer, Heidelberg (DE); Martin Stein, Mannheim (DE)

(21) Appl. No.: 14/390,019

(22) PCT Filed: Apr. 2, 2013
(86) PCT No.: PCT/EP2013/056963

§ 371 Date: Oct. 1, 2014

Related U.S. Application Data
(63) Continuation of application No. 13/828,862, filed on Mar. 14, 2013.
(60) Provisional application No. 61/619,255, filed on Apr. 2, 2012.
(60) Provisional application No. 61/757,805, filed on Jan. 29, 2013.

(51) Int. Cl. G06F 19/00

(52) U.S. Cl. CPC G06F 19/345
USPC 705/2

(57) ABSTRACT

Systems and methods are described herein for disease knowledge modeling and clinical treatment decision support. Disease or indication information, including identification of biomolecular entities associated with the indication may be culled through data mining to create a knowledge model of the indication. In some embodiments, the knowledge model may comprise a network of associations between molecular entities, including drug targets and biomarkers, genes, pathways. The model is used for prioritizing treatment decisions, for treatments comprising one or more medications associated with one or more molecular entities in the model. The priority of a suggested treatment depends on at least one property of one or more medications of the suggested treatment.

### FIELD OF THE DISCLOSURE

The present disclosure relates to systems and methods for bioinformatics and data processing. In particular, the present disclosure relates to methods and systems for disease knowledge modeling and prioritizing possible treatment options based on biomedical data and associated disease models.

### BACKGROUND OF THE DISCLOSURE

A large number of publications exist regarding human disease etiology and progression, discussing various molecular entities such as proteins, small molecules such as metabolites, nutrients, drugs, transporters, enzymes, pathways, and other information. Additionally, with revolutionary advances occurring in profiling technologies, the amount of new literature is constantly increasing. With such a large mass of data, it may be difficult for researchers to easily and quickly perform analyses, and is difficult for clinicians to identify personalized patient treatment options.

### BRIEF SUMMARY OF THE DISCLOSURE

In one aspect, the present disclosure is directed to systems and methods for disease knowledge modeling and clinical treatment decision support. Disease or indication information, including identification of bio-molecular entities associated with the indication, such as protein targets, pathways, enzymes, drugs, transporters, or other entities may be culled through data mining from journals, abstracts, clinical trials, medication information, genome information, gene expression, diagnostic materials, research reports, regulatory information, histology or pathology reports, medical records, in particular EMRs, or any other available sources, to create a knowledge model of the indication. In some embodiments, the knowledge model may comprise a network of associations between molecular entities, including drug targets and biomarkers, genes, pathways. The model may be combined with patient-specific variant information and historical treatment records to identify and prioritize treatment decisions. The choice of an appropriate treatment for a patient in any condition can benefit from these models, and from understanding the most important properties of medications and molecular players in the etiology and progression of that condition.

In one aspect, the present disclosure is directed to a method for prioritizing treatment decisions. The method includes retrieving, by an analyzer executed by a processor of a computing device, an identification of a patient indication. The method also includes identifying, by the analyzer, one or more molecular entities associated with the patient indication. The method also includes retrieving, by the analyzer from a medication information database, a plurality of identifications of medications associated with one or more identified molecular entities. The method includes generating, by the analyzer, a prioritized list of suggested treatments, each comprising one or more of the plurality of medications, wherein the priority of a suggested treatment depends on at least one property of the one or more medications of the suggested treatment.

Advantageously, a method is provided that begins with the choice of a specific human condition, henceforth called indication, for example a disease or a drug side effect. Once specified, the method focuses on the area of knowledge space that is relevant to the chosen condition, e.g. all publications that mention the condition. This sub-space is then analyzed using multiple bioinformatics and text-data mining methods, which independently provide a score, in some embodiments a weighted score, for each medication or for each gene/protein, based on their clinical and molecular importance to the chosen condition.

In a preferred implementation of the method, generating the prioritized list of suggested treatments comprises computing a score for each treatment and sorting the treatments according to the score. One preferred way of computing such a score for a treatment is aggregating over the one or more medications included in the treatment and over one or more considered properties of medications, representing each property of each medication by a sub-score.

In one embodiment of the method, the score comprises a count or a weighted count of the medications comprised in the suggested treatment. In a further embodiment of the method, generating the prioritized list of suggested treatments comprises ordering the suggested treatments in order from fewest medications comprised in the suggested treatment to most.

In another embodiment of the method, the score comprises a count or a weighted count of the molecular entities affected by the one or more medications of the suggested treatment. In a further embodiment of the method, generating the prioritized list of suggested treatments comprises ordering each suggested treatment in order from a highest count or highest weighted count of the molecular entities affected by the one or more medications of the suggested treatment to a lowest count or lowest weighted count. In one embodiment of the method, the prioritized list of treatments is generated by first sorting each suggested treatment from a highest count or highest weighted count of the molecular entities affected by the one or more medications of the suggested treatment to a lowest count or lowest weighted count and then ordering each group of treatments that are equal with respect to that count in an order from fewest medications comprised in the suggested treatment to most. In an alternative embodiment of the method, the prioritized list of treatments is generated by first ordering the suggested treatments in an order from fewest medications comprised in the suggested treatment to most and then sorting each group of treatments that are equal with respect to that count of medications comprised in the suggested treatment from a highest count or highest weighted count of the molecular entities affected by the one or more medications of the suggested treatment to a lowest count or lowest weighted count.

In another embodiment of the method, a property of the one or more medications of the suggested treatment is a property of the one or more identified molecular entities associated with the medications. Thus, some properties of one or more medications of the suggested treatment are derived from properties of their targets. In such a case, a sub-score representing the property of the medication may be computed by aggregating over sub-sub-scores that represent properties of the targets of the medications. In one embodiment of this, the sub-score of a property of a medication may be computed as an average of the sub-sub-scores of a corresponding property of all those molecular entities in the indication-specific entity set that are targets of that medication. In case of genes as molecular entities, the property of interest may be whether they are oncogenes. To each gene may then be assigned a sub-sub-score, for instance by computing a measure of co-occurrence of an identification of the gene and any of the common names of that gene with any of a set of terms that are indicative of oncogenes, e.g. “oncogene” or “cancer driver”. Then, a corresponding sub-score for a medication may be defined by computing an average of the sub-sub-scores of the genes that encode the proteins that are targets of the medication.

Further preferred properties of proteins as molecular entities, which may be used to define relevant properties of medications by a process as described above, include whether the protein is implicated in a core cancer pathway, whether a knock-out of the protein is embryonic lethal, whether the protein or its encoding gene is implicated in certain GO (gene ontology) categories, and/or whether the protein or its encoding gene is included in OMIM (Online Mendelian Inheritance in Man) or in some other disease gene database. Some further properties of proteins may also depend on an indication, including whether any predictive biomarker for an indication relates to the protein, whether any prognostic biomarker for an indication relates to the protein, whether the protein is found associated with an indication based on text mining co-occurrence, whether the protein is a known oncogene for some cancer type, and/or whether the protein is a known suppressor of some cancer type. In the context of this invention, such properties may be considered only for the patient indication, or may also be aggregated over related indications, or over all indications to form properties for use in treatment prioritization. A corresponding sub-score for a medication may be defined by computing an average of the sub-sub-scores of the proteins that are targets of the medication.

In one embodiment of the method, the priority of a suggested treatment is further based on a stage of development of a medication of the suggested treatment. In one embodiment of the method, a property of the one or more medications of the suggested treatment is a stage of development of the one or more medications of the suggested treatment. The developmental stage of a medication may differ for different indications. For a given patient indication, the treatment priorities may take into account the developmental stage of a medication for that given indication, or for related indications, or for any indication at all. For example, if the patient indication is a non-small cell lung cancer, other types of lung cancer may be considered closely related indications, and other cancer types may be considered weakly related indications, whereas all other indications might be considered unrelated.

One way of generating a prioritized list of treatments according to developmental stage of medication is to first list all treatments that include a medication that is approved, then all of the remaining treatments that include a medication that is in clinical development stage III, then all of the still remaining treatments that include a medication that is in clinical development stage II, then all of the still remaining treatments that include a medication that is in clinical development stage I, then all of the still remaining treatments that include a medication that is in preclinical development, then all still remaining treatments. While this scheme is intuitive and clear, more flexible schemes, which are included in preferred embodiments of the method, may provide advantages. In one embodiment of the method, the prioritized list of treatments is generated by first sorting treatments according to a first property of medications, and then sorting each group of treatments that are equal with respect to that first property internally according to a second property. For example, all treatments that have the same developmental stage may be sorted according to a measure of co-occurrence of identifications of their targets with identifications of the indication as found by data mining a database of bio-medical texts. Hence, relative priorities of all treatments within each of the six developmental stage groups are also well defined.

One preferred way of generating a prioritized list of treatments according to developmental stage of medication is to take into account the developmental status of medications for indications other than the patient indication by assigning sub-scores to the developmental stage property of medications that are defined as a sum over indications of a weight that depends both on the degree of relationship of the indication to the patient indication and on the developmental stage of the medication for the indication. It is preferred that, for any fixed degree of relatedness, the weight increases with higher developmental stage, and for any fixed developmental stage, the weight increases with increasing degree of relationship.

In one embodiment of the method, identifying one or more molecular entities associated with the patient indication comprises searching a literature database for identifications for identifications of a molecular entity having a measure of co-occurance with identifications of the patient indication greater than a first threshold. As far from all relevant bio-medical knowledge is available in structured databases, such as relational databases, bio-medical publications are considered as an important source of facts that can help to prioritize treatments. Therefore, data mining methods are used as one means to identify molecular entities, especially genes and the proteins encoded by those genes that are associated with an indication.

In another embodiment of the method, the method comprises identifying at least one genetic variant associated with the patient indication. In a preferred embodiment, identifying at least one genetic variant associated with the patient indication comprises searching a literature database for identifications of a genetic variant having a measure of co-occurrence with identifications of the patient indication greater than a second threshold.

In some embodiments of the method, identifying one or more molecular entities associated with the patient indication further comprises identifying activation or repression of a gene or of a protein by the genetic variant or other molecular perturbations caused by the genetic variant that modify (i.e. increases or decreases) the normal function of a gene or protein, such as amplification, deletion, or changes in expression or epigenetic status, and selecting said protein or gene for inclusion in the set of the one or more identified molecular entities associated with the patient indication. In other embodiments of the method, identifying activation or repression of a gene or of a protein by the genetic variant or other molecular perturbations caused by the genetic variant that modify the function of a gene or protein comprises searching a literature database for identifications of the protein or gene and/or the genetic variant having a measure of co-occurrence with identifications of molecular perturbations and/or identifications of activation, repression, amplification, deletion and/or change. Identifications of change may in particular comprise any type of mutations (e.g., single nucleotide polymorphisms (SNPs) or insertions or deletions (indels)) or modifications. In some embodiments of the method, identifying one or more molecular entities associated with the patient indication comprises extracting a sub-graph from a global molecular entity graph, the sub-graph comprising the plurality of proteins or genes.

The method for prioritizing treatment decisions may further comprise suggesting to the patient a treatment of the indication if the treatment is well ranked in the prioritized list of suggested treatments and/or suggesting to the patient a treatment as contraindicated for the patient if the treatment is not well ranked in the prioritized list of suggested treatments. Well ranked may in particular refer to a high score and not well ranked may refer to a low score as described above.

In another aspect, the present disclosure is directed to a system which is configured for executing one of the methods as described herein. The present disclosure is directed to a system for prioritizing treatment decisions. The system includes a computing device comprising a processor and a memory. The processor executes an analyzer configured for retrieving an identification of a patient indication. The analyzer is further configured for identifying one or more molecular entities associated with the patient indication. The analyzer is also configured for retrieving, from a treatment information database or from a medication information database, a plurality of identifications of medications associated with one or more identified molecular entities. The analyzer is further configured for generating a prioritized list of suggested treatments, each comprising one or more of the plurality of medications, wherein the priority of a suggested treatment depends on at least one property of the one or more medications of the suggested treatment.

In one embodiment, the analyzer is further configured for searching a literature database for identifications of a molecular entity having a measure of co-occurrence with identifications of the patient indication greater than a first threshold. In another embodiment, the analyzer is further configured for identifying at least one genetic variant associated with the patient indication. In a further embodiment, the analyzer is further configured for searching a literature database for identifications of a genetic variant having a measure of co-occurrence with identifications of the patient indication greater than a second threshold. In still another embodiment, the analyzer is further configured for identifying activation or repression of a gene or of a protein by the genetic variant or other molecular perturbations caused by the genetic variant that modify (i.e. increase or decrease) the normal function of a gene or protein, such as amplification, deletion, or changes in expression or epigenetic status, and selecting said protein or gene for inclusion in the set of the one or more identified molecular entities associated with the patient indication. In a further embodiment, the analyzer is further configured for searching a literature database for identifications of the protein or gene or molecular perturbations having a measure of co-occurrence with identifications of the genetic variant and identifications of activation, repression, amplification, deletion and other types of change. In some embodiments, the analyzer is further configured for extracting a sub-graph from a global molecular entity graph, the sub-graph comprising the selected subset of the one or more identified molecular entities.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising client device in communication with server device;

FIGS. 1B and 1C are block diagrams depicting embodiments of computing devices useful in connection with the methods and systems described herein;

FIGS. 2A-2B are block diagrams depicting additional embodiments of computers useful in connection with the methods and systems described herein;

FIG. 3A is a block diagram of an embodiment of a system for multivariate analysis of adverse event data;

FIG. 3B is a diagram of an example embodiment of a global molecular entity graph;

FIG. 3C is a diagram of an example embodiment of extracted sub-graphs;

FIG. 4A is a block diagram of an embodiment of a system for disease knowledge modeling and clinical treatment decision support;

FIG. 4B is a block diagram of an embodiment of a method for analysis of disease information for disease knowledge modeling;

FIG. 4C is a block diagram of an embodiment of a system for building a semantic indication model;

FIG. 5 is a block diagram of an embodiment of a system for utilizing semantic indication models and histopathology reports for differentiation analysis of a disease knowledge model;

FIG. 6 is a flow diagram of an embodiment of a method for prioritizing treatment decisions;

FIG. 7 is a tree diagram of an exemplary disease model and prioritized medication information;

FIG. 8 is a flow diagram depicting an embodiment of a method for selecting and prioritizing possible treatment options for a patient.

### DETAILED DESCRIPTION

Knowledge about the molecular mechanisms involved in human disease etiology and progression can be fundamental to advancing the fields of clinical research and drug development. With advances in biomedical sciences, the nature of such knowledge has gradually shifted from predominantly phenotypic to holistic molecular descriptions of bio-molecular processes and networks, which describe the biochemical interplay between individual bio-molecules, including proteins, genes coding for proteins, small molecules such as metabolites, nutrients or drugs and phenotypic effects at the patient level, such as clinical stages of disease progression, processes at the cellular level, drug response or resistance.

At the molecular level, information about the abundance and assembly of proteins in specific disease indications can assist in the elucidation of detailed and accurate disease models. Advances in speed, cost and precision of genome sequencing renders access to this information possible and also permits the investigation of human disease at the level of the individual patient.

Prior to discussing specifics of methods and systems for disease knowledge modeling and prioritization of patient treatment options, it may be helpful to briefly define a few terms as used herein. These definitions are not intended to limit the use of the terms, but rather may provide additional or alternate definitions for use of the terms within some contexts. Accordingly, context may clarify whether, for example, the term indication refers to a symptom or disease, a flag in a database, or a selection by a user. Additionally, the following list of definitions is not intended to be exhaustive, but rather discuss a few key terms that may be helpful to those of skill in the art.

Adverse event: In pharmacology, an adverse event may refer to any unexpected or dangerous reaction to a drug. An unwanted effect caused by the administration of a drug. The onset of the adverse reaction may be sudden or develop over time. Also interchangeably called: adverse drug event (ADE), adverse drug reaction (ADR), adverse effect or adverse reaction.

Absorption, Distribution, Metabolism, Excretion (ADME): ADME refers to the standard pharmacokinetic mechanism of a drug.

Adverse Event Reporting System (AERS): AERS is a computerized information database designed to support the FDA's post-marketing safety surveillance program for all approved drug and therapeutic biologic products. The FDA uses AERS to monitor for new adverse events and medication errors that might occur with these marketed products.

Bioavailability: Also referred to as availability, this is the amount of a drug that is absorbed into circulation after administration of a specific dosage.

Biomarker: The term “biomarker” may be generally referred to in two different ways. In one definition, biomarkers may be simply any measurable quantities. In an alternate definition used herein, the term “biomarker” may also be used for predictive rules that are based on a biomarker. Such predictive rules may comprise a combination of a measurable quantity (e.g. a biomarker as discussed above in the first definition), a value range, an indication, a treatment option, and/or an effect on the outcome. For example, “response”, “resistance”, and “risk” may be possible qualitative descriptions of the type of effect. Accordingly, via such predictive rules, two otherwise similar cohorts of patients with a given indication may be compared, where the first cohort comprises patients with a biomarker measurement value outside a given range and the second cohort comprises patients with the biomarker measurement value inside the given range. The outcomes achieved by a given treatment in both cohorts may differ, as described by a given effect on the outcome. In some implementations, these predictive rules may be referred to variously as an “actionable biomarker”, a “predictive biomarker”, or a “theranostic biomarker”. A biomarker or measured quantity may apply to more than one predictive rule, for example related to different indications or different drugs. Accordingly, in some instances of the term “biomarker” in this disclosure, the predictive rule may rather be meant than the strict biomarker. However, for the person skilled in the art, this will be clear from the context as well.

Challenge-dechallenge-rechallenge (CDR): This is a medical testing protocol in which a medicine (or drug) is administered (challenge), withdrawn (dechallenge), then re-administered (rechallenge), while being monitored for adverse effects (reactions) at each stage.

Contingency table (or matrix): Also referred to as cross tabulation or cross tab. A contingency table is often used to record and analyze the relation between two or more categorical variables. It displays the (multivariate) frequency distribution of the variables in a matrix format.

Co-occurance, measure of co-occurrence: The basic measure of co-occurrence is the count of entities that contain identifications of both components of the considered pair, e.g. an identification of a given indication and an identification of a given protein. The inferred relationships may be of higher accuracy when thresholding is not applied to the raw counts, but rather to statistics that are derived from these counts and possibly further information. For example, frequentist statistics like p-values or likelihoods may be computed based on models of (in)dependence or (dis)proportionality. More specifically, one may consider all pairs of protein and indication as related that pass a Fisher exact test on the contingency table formed by the co-occurrence count of the pair together with the corresponding marginal counts. Alternatively, empirical Bayes models or Bayesian models may be used to approximate posterior probabilities of the pair forming a relation, especially if appropriate knowledge on prior probabilities is available. All these statistics, in particular p-values, likelihoods or posterior probabilities, are henceforth called measures of co-occurrence; however it is understood that usually wherever the phrases “frequency of co-occurrence” or “co-occurrence correlation” or the like are used, any other measure of co-occurrence may alternatively be used, and possibly preferredly so.

Developmental stage: The developmental stage of a medication is defined in relation to an indication. For any given indication, a medication may be approved by some regulatory body (e.g. the FDA or the EMA), or it may be in any of the steps of an approval process, or it may not yet been subjected to the first step of an approval process.

Drug interaction: A drug interaction is a situation in which a substance affects the activity of a drug, i.e. the effects are increased or decreased, or they produce a new effect that neither produces on its own. However, interactions may also exist between drugs & foods (drug-food interactions), as well as drugs & herbs (drug-herb interactions). These may occur out of accidental misuse or due to lack of knowledge about the active ingredients involved in the relevant substances or the underlying molecular mechanisms.

Entity Coverage/Co-Entity Coverage: The Entity Coverage is an estimate that refers to the significance with which a first entity (E1) is related with a second entity (E2) in a data set. It is calculated from the number of data entries containing E1 and E2 divided by the overall number of data entries containing E1. The Co-Entity Coverage is calculated from the number of data entries containing E1 and E2 divided by the overall number of data entries containing E2. This method gives thus an indication for the significance of entity relations in subsets of data.

Gamma Poisson Shrinker: Advanced method for Pharmacovigilance Signal Detection. In contrast to simple methods that focus on a specific AE-drug-combination at a time (encoded in 2*2 contingency tables), it can directly use contingency tables that range over all drugs and AEs.

Idiosyncratic response: An abnormal response from a drug that is specific to the person having the response.

Indication (or ‘drug use’): In medicine, an indication is a valid reason to use a certain test, medication, procedure, or surgery. An indication may thus refer to a disease, a symptom, or diagnosis. The opposite of indication is contraindication.

Identification of an indication: The indication of a patient may be identified according to a disease ontology, for instance ICD-10, MeSH, or MedDRA. For certain classes of indications there may also be specialized ontologies that may offer advantages like more precise categorization of the indication. For example, in oncology it may be beneficial to use ICD-O-3 and/or the TNM staging system.

Metabolizing enzyme: A protein that metabolizes a medication; the enzyme may help transforming a pro-drug to its pharmacologically active chemical compound form or it may play a role in its degradation.

Molecular mechanism: The flow of events that take place in the molecular level when a drug is administered. The molecular mechanisms can be highly complex due to the variety of participating components (e.g., drugs, organs, cells, proteins, etc.), systems (e.g., pathways, disease networks, etc.), entity interrelations (e.g., drug-target, drug-metabolizing enzyme, carriers, transporters, overlapping systems and pathways, etc.), and molecular aberrations (e.g., mutations, radiation damage, etc.). Components of the molecular mechanism, such as protein targets, pathways, transporters, drugs, or drug classes may be referred to variously as molecular entities or bio-molecular entities.

Side effect: Any unintended effect of a pharmaceutical product occurring at a dose normally used in man, which is related to the pharmacological properties of the drug. A side effect may frequently correspond to an indication. For example, nausea may be a side effect of a first drug, but may be an indication to be treated by a second drug. A negative side effect may also be referred to as an adverse event.

Target: A direct target of a medication is any molecular entity (often a protein) to which an active compound of the medication (potentially a metabolite of an ingredient of the medication) binds. For instance, COX-1 (also known as PTGS1) is a direct target of Aspirin. The term target may also be used to include molecular entities indirectly affected by the medication, for instance molecular interaction partners of direct targets.

For purposes of reading the description of the various embodiments below, the following descriptions of the sections of the specification and their respective contents may be helpful.

Section A describes a network environment and computing environment which may be useful for practicing embodiments described herein.

Section B describes embodiments of systems and methods for disease knowledge modeling.

A. Computing and Network Environment

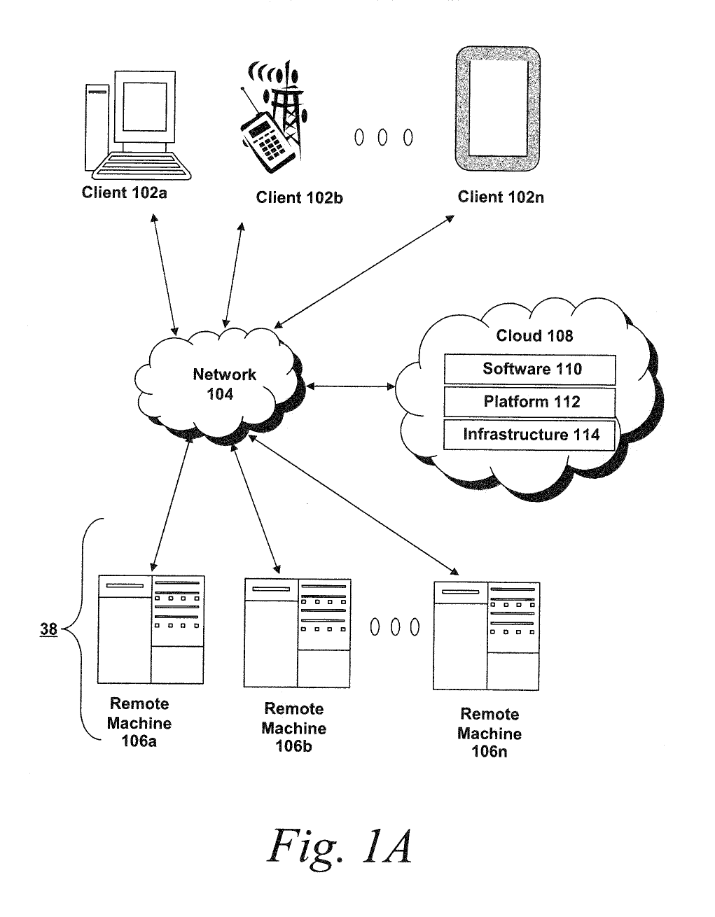

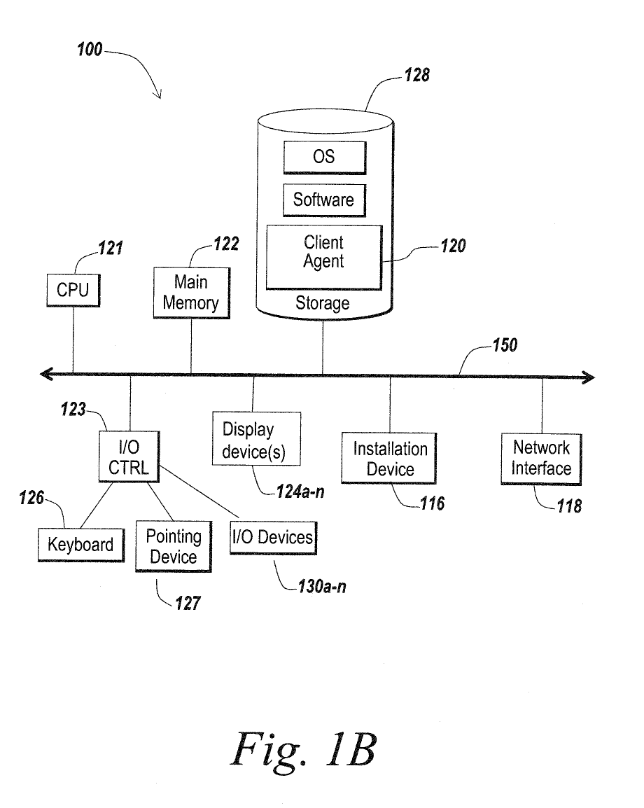

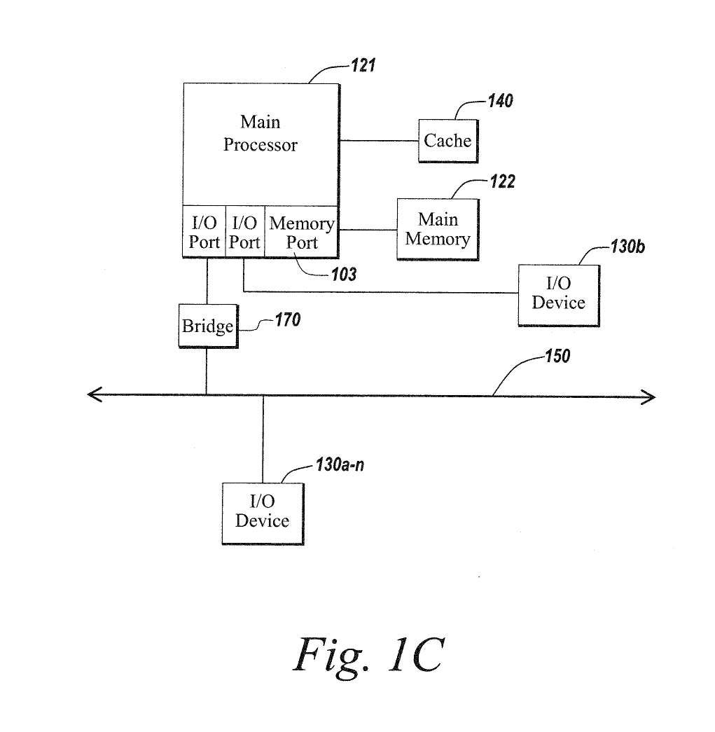

Prior to discussing specific embodiments of the present solution, it may be helpful to describe aspects of the operating environment as well as associated system components (e.g., hardware elements) in connection with the methods and systems described herein. It is to be noted that all methods for disease knowledge modeling and prioritizing possible treatment options based on mined biomedical data and associated disease models as described herein are preferably computer implemented methods. Referring to FIG. 1A, an embodiment of a network environment is depicted. In brief overview, the network environment includes one or more clients 102a-102n (also generally referred to as local machine(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ a public network. In still another of these embodiments, networks 104 and 104′ may both be private networks.

The network 104 may be connected via wired or wireless links. Wired links may include Digital Subscriber Line (DSL), coaxial cable lines, or optical fiber lines. The wireless links may include BLUETOOTH, Wi-Fi, Worldwide Interoperability for Microwave Access (WiMAX), an infrared channel or satellite band. The wireless links may also include any cellular network standards used to communicate among mobile devices, including standards that qualify as 1G, 2G, 3G, or 4G. The network standards may qualify as one or more generation of mobile telecommunication standards by fulfilling a specification or standards such as the specifications maintained by International Telecommunication Union. The 3G standards, for example, may correspond to the International Mobile Telecommunications-2000 (IMT-2000) specification, and the 4G standards may correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards may use various channel access methods e.g. FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network 104 may vary widely and the network 104 can be a body area network (BAN), a personal area network (PAN), a local-area network (LAN), e.g. Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network which is virtual and sits on top of one or more layers of other networks 104′. The network 104 may be of any such network topology as known to those ordinarily skilled in the art capable of supporting the operations described herein. The network 104 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv6), or the link layer. The network 104 may be a type of a broadcast network, a telecommunications network, a data communication network, or a computer network.

In some embodiments, the system may include multiple, logically-grouped servers 106. In one of these embodiments, the logical group of servers may be referred to as a server farm 38 or a machine farm 38. In another of these embodiments, the servers 106 may be geographically dispersed. In other embodiments, a machine farm 38 may be administered as a single entity. In still other embodiments, the machine farm 38 includes a plurality of machine farms 38. The servers 106 within each machine farm 38 can be heterogeneous—one or more of the servers 106 or machines 106 can operate according to one type of operating system platform (e.g., WINDOWS NT, manufactured by Microsoft Corp. of Redmond, Wash.), while one or more of the other servers 106 can operate on according to another type of operating system platform (e.g., Unix, Linux, or Mac OS X).

In one embodiment, servers 106 in the machine farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high performance storage systems on localized high performance networks. Centralizing the servers 106 and storage systems and coupling them with advanced system management tools allows more efficient use of server resources.

The servers 106 of each machine farm 38 do not need to be physically proximate to another server 106 in the same machine farm 38. Thus, the group of servers 106 logically grouped as a machine farm 38 may be interconnected using a wide-area network (WAN) connection or a metropolitan-area network (MAN) connection. For example, a machine farm 38 may include servers 106 physically located in different continents or different regions of a continent, country, state, city, campus, or room. Data transmission speeds between servers 106 in the machine farm 38 can be increased if the servers 106 are connected using a local-area network (LAN) connection or some form of direct connection. Additionally, a heterogeneous machine farm 38 may include one or more servers 106 operating according to a type of operating system, while one or more other servers 106 execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alto, Calif.; the Xen hypervisor, an open source product whose development is overseen by Citrix Systems, Inc.; the HYPER-V hypervisors provided by Microsoft or others. Hosted hypervisors may run within an operating system on a second software level. Examples of hosted hypervisors may include VMware Workstation and VIRTUALBOX.

Management of the machine farm 38 may be de-centralized. For example, one or more servers 106 may comprise components, subsystems and modules to support one or more management services for the machine farm 38. In one of these embodiments, one or more servers 106 provide functionality for management of dynamic data, including techniques for handling failover, data replication, and increasing the robustness of the machine farm 38. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In one embodiment, the server 106 may be referred to as a remote machine or a node. In another embodiment, a plurality of nodes 290 may be in the path between any two communicating servers.

In some embodiments, A cloud computing environment may provide client 102 with one or more resources provided by a network environment. The cloud computing environment may include one or more clients 102a-102n, in communication with the cloud 108 over one or more networks 104. Clients 102 may include, e.g., thick clients, thin clients, and zero clients. A thick client may provide at least some functionality even when disconnected from the cloud 108 or servers 106. A thin client or a zero client may depend on the connection to the cloud 108 or server 106 to provide functionality. A zero client may depend on the cloud 108 or other networks 104 or servers 106 to retrieve operating system data for the client device. The cloud 108 may include back end platforms, e.g., servers 106, storage, server farms or data centers.

The cloud 108 may be public, private, or hybrid. Public clouds may include public servers 106 that are maintained by third parties to the clients 102 or the owners of the clients. The servers 106 may be located off-site in remote geographical locations as disclosed above or otherwise. Public clouds may be connected to the servers 106 over a public network. Private clouds may include private servers 106 that are physically maintained by clients 102 or owners of clients. Private clouds may be connected to the servers 106 over a private network 104. Hybrid clouds 108 may include both the private and public networks 104 and servers 106.

The cloud 108 may also include a cloud based delivery, e.g. Software as a Service (SaaS) 110, Platform as a Service (PaaS) 112, and Infrastructure as a Service (IaaS) 114. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 102 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 102 may also access SaaS resources through smartphone or tablet applications, including, e.g., Salesforce Sales Cloud, or Google Drive app. Clients 102 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client 102 and server 106 may be deployed as and/or executed on any type and form of computing device, e.g. a computer, network device or appliance capable of communicating on any type and form of network and performing the operations described herein. FIGS. 1B and 1C depict block diagrams of a computing device 100 useful for practicing an embodiment of the client 102 or a server 106. As shown in FIGS. 1B and 1C, each computing device 100 includes a central processing unit 121, and a main memory unit 122. As shown in FIG. 1B, a computing device 100 may include a storage device 128, an installation device 116, a network interface 118, an I/O controller 123, display devices 124a-124n, a keyboard 126 and a pointing device 127, e.g. a mouse. The storage device 128 may include, without limitation, an operating system, software, and a software of Clinical Decision Support Device 100. As shown in FIG. 1C, each computing device 100 may also include additional optional elements, e.g. a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The computing device 100 may be based on any of these processors, or any other processor capable of operating as described herein. The central processing unit 121 may utilize instruction level parallelism, thread level parallelism, different levels of cache, and multi-core processors. A multi-core processor may include two or more processing units on a single computing component. Examples of a multi-core processors include the AMD PHENOM IIX2, INTEL CORE i5 and INTEL CORE i7.

Main memory unit 122 may include one or more memory chips capable of storing data and allowing any storage location to be directly accessed by the microprocessor 121. Main memory unit 122 may be volatile and faster than storage 128 memory. Main memory units 122 may be Dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 122 or the storage 128 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 122 may be based on any of the above described memory chips, or any other available memory chips capable of operating as described herein. In the embodiment shown in FIG. 1B, the processor 121 communicates with main memory 122 via a system bus 150 (described in more detail below). FIG. 1C depicts an embodiment of a computing device 100 in which the processor communicates directly with main memory 122 via a memory port 103. For example, in FIG. 1C the main memory 122 may be DRDRAM.

FIG. 1C depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1C, the processor 121 communicates with various I/O devices 130 via a local system bus 150. Various buses may be used to connect the central processing unit 121 to any of the I/O devices 130, including a PCI bus, a PCI-X bus, or a PCI-Express bus, or a NuBus. For embodiments in which the I/O device is a video display 124, the processor 121 may use an Advanced Graphics Port (AGP) to communicate with the display 124 or the I/O controller 123 for the display 124. FIG. 1C depicts an embodiment of a computer 100 in which the main processor 121 communicates directly with I/O device 130b or other processors 121′ via HYPERTRANSPORT, RAPIDIO, or INFINIBAND communications technology. FIG. 1C also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WU, Nintendo WII U GAMEPAD, or Apple IPHONE. Some devices 130a-130n allow gesture recognition inputs through combining some of the inputs and outputs. Some devices 130a-130n provides for facial recognition which may be utilized as an input for different purposes including authentication and other commands. Some devices 130a-130n provides for voice recognition and inputs, including, e.g., Microsoft KINECT, SIRI for IPHONE by Apple, Google Now or Google Voice Search.

Additional devices 130a-130n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augment reality devices. The I/O devices may be controlled by an I/O controller 123 as shown in FIG. 1B. The I/O controller may control one or more I/O devices, such as, e.g., a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices. In further embodiments, an I/O device 130 may be a bridge between the system bus 150 and an external communication bus, e.g. a USB bus, a SCSI bus, a FireWire bus, an Ethernet bus, a Gigabit Ethernet bus, a Fibre Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. stereoscopy, polarization filters, active shutters, or autostereoscopy. Display devices 124a-124n may also be a head-mounted display (HMD). In some embodiments, display devices 124a-124n or the corresponding I/O controllers 123 may be controlled through or have hardware support for OPENGL or DIRECTX API or other graphics libraries.

In some embodiments, the computing device 100 may include or connect to multiple display devices 124a-124n, which each may be of the same or different type and/or form. As such, any of the I/O devices 130a-130n and/or the I/O controller 123 may include any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may include multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices 100a or 100b connected to the computing device 100, via the network 104. In some embodiments software may be designed and constructed to use another computer's display device as a second display device 124a for the computing device 100. For example, in one embodiment, an Apple iPad may connect to a computing device 100 and use the display of the device 100 as an additional display screen that may be used as an extended desktop. One ordinarily skilled in the art will recognize and appreciate the various ways and embodiments that a computing device 100 may be configured to have multiple display devices 124a-124n.

Referring again to FIG. 1B, the computing device 100 may comprise a storage device 128 (e.g. one or more hard disk drives or redundant arrays of independent disks) for storing an operating system or other related software, and for storing application software programs. Examples of storage device 128 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage device 128 may be non-volatile, mutable, or read-only. Some storage device 128 may be internal and connect to the computing device 100 via a bus 150. Some storage device 128 may be external and connect to the computing device 100 via a I/O device 130 that provides an external bus. Some storage device 128 may connect to the computing device 100 via the network interface 118 over a network 104, including, e.g., the Remote Disk for MACBOOK AIR by Apple. Some client devices 100 may not require a non-volatile storage device 128 and may be thin clients or zero clients 102. Some storage device 128 may also be used as a installation device 116, and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Client device 100 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 102. An application distribution platform may include a repository of applications on a server 106 or a cloud 108, which the clients 102a-102n may access over a network 104. An application distribution platform may include application developed and provided by various developers. A user of a client device 102 may select, purchase and/or download an application via the application distribution platform.

Furthermore, the computing device 100 may include a network interface 118 to interface to the network 104 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). In one embodiment, the computing device 100 communicates with other computing devices 100′ via any type and/or form of gateway or tunneling protocol e.g. Secure Socket Layer (SSL) or Transport Layer Security (TLS), or the Citrix Gateway Protocol manufactured by Citrix Systems, Inc. of Ft. Lauderdale, Fla. The network interface 118 may comprise a built-in network adapter, network interface card, PCMCIA network card, EXPRESSCARD network card, card bus network adapter, wireless network adapter, USB network adapter, modem or any other device suitable for interfacing the computing device 100 to any type of network capable of communication and performing the operations described herein.

A computing device 100 of the sort depicted in FIGS. 1B and 1C may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, and WINDOWS 8 all of which are manufactured by Microsoft Corporation of Redmond, Wash.; MAC OS and iOS, manufactured by Apple, Inc. of Cupertino, Calif.; and Linux, a freely-available operating system, e.g. Linux Mint distribution (“distro”) or Ubuntu, distributed by Canonical Ltd. of London, United Kingdom; or Unix or other Unix-like derivative operating systems; and Android, designed by Google, of Mountain View, Calif., among others. Some operating systems, including, e.g., the CHROME OS by Google, may be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 is a gaming system. For example, the computer system 100 may comprise a PLAYSTATION 3, or PERSONAL PLAYSTATION PORTABLE (PSP), or a PLAYSTATION VITA device manufactured by the Sony Corporation of Tokyo, Japan, a NINTENDO DS, NINTENDO 3DS, NINTENDO WU, or a NINTENDO WII U device manufactured by Nintendo Co., Ltd., of Kyoto, Japan, an XBOX 360 device manufactured by the Microsoft Corporation of Redmond, Wash. The gaming system may be repurposed, for example to form inexpensive nodes of a grid computer.

In some embodiments, the computing device 100 is a digital audio player such as the Apple IPOD, IPOD Touch, and IPOD NANO lines of devices, manufactured by Apple Computer of Cupertino, Calif. Some digital audio players may have other functionality, including, e.g., a gaming system or any functionality made available by an application from a digital application distribution platform. For example, the IPOD Touch may access the Apple App Store. In some embodiments, the computing device 100 is a portable media player or digital audio player supporting file formats including, but not limited to, MP3, WAV, M4A/AAC, WMA Protected AAC, RIFF, Audible audiobook, Apple Lossless audio file formats and .mov, .m4v, and .mp4MPEG-4 (H.264/MPEG-4 AVC) video file formats.

In some embodiments, the computing device 100 is a tablet e.g. the IPAD line of devices by Apple; GALAXY TAB family of devices by Samsung; or KINDLE FIRE, by Amazon.com, Inc. of Seattle, Wash. In other embodiments, the computing device 100 is a eBook reader, e.g. the KINDLE family of devices by Amazon.com, or NOOK family of devices by Barnes & Noble, Inc. of New York City, N.Y.

In some embodiments, the communications device 102 includes a combination of devices, e.g. a smartphone combined with a digital audio player or portable media player. For example, one of these embodiments is a smartphone, e.g. the IPHONE family of smartphones manufactured by Apple, Inc.; a Samsung GALAXY family of smartphones manufactured by Samsung, Inc; or a Motorola DROID family of smartphones. In yet another embodiment, the communications device 102 is a laptop or desktop computer equipped with a web browser and a microphone and speaker system, e.g. a telephony headset. In these embodiments, the communications devices 102 are web-enabled and can receive and initiate phone calls. In some embodiments, a laptop or desktop computer is also equipped with a webcam or other video capture device that enables video chat and video call.

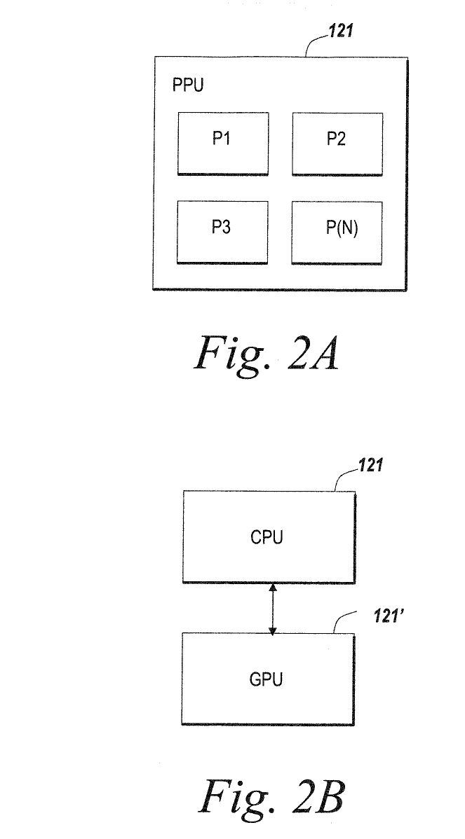

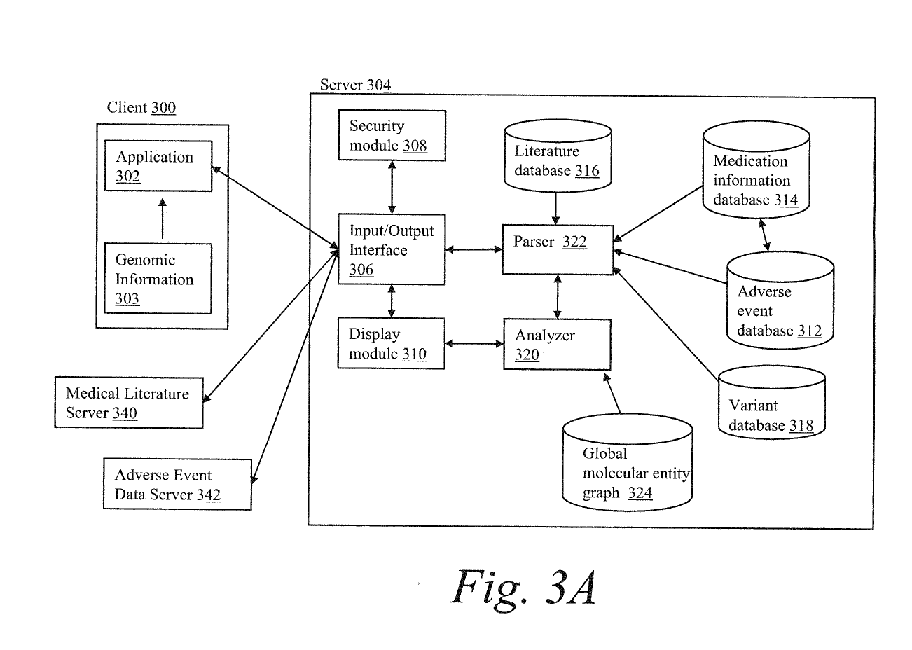

As shown in FIG. 2A, the computing device 100 may comprise multiple processors and may provide functionality for simultaneous execution of instructions or for simultaneous execution of one instruction on more than one piece of data. In some examples, the computing device 100 may comprise a parallel processor with one or more cores. In one of these examples, the computing device 100 is a shared memory parallel device, with multiple processors and/or multiple processor cores, accessing all available memory as a single global address space. In another of these examples, the computing device 100 is a distributed memory parallel device with multiple processors each accessing local memory only. In still another of these examples, the computing device 100 has both some memory which is shared and some memory which can only be accessed by particular processors or subsets of processors. In still even another of these examples, the computing device 100, such as a multicore microprocessor, combines two or more independent processors into a single package, often a single integrated circuit (IC). In yet another of these examples, the computing device 100 includes a chip having a CELL BROADBAND ENGINE architecture and including a Power processor element and a plurality of synergistic processing elements, the Power processor element and the plurality of synergistic processing elements linked together by an internal high speed bus, which may be referred to as an element interconnect bus.

In some examples, the processors provide functionality for execution of a single instruction simultaneously on multiple pieces of data (SIMD). In other examples, the processors provide functionality for execution of multiple instructions simultaneously on multiple pieces of data (MIMD). In still other examples, the processor may use any combination of SIMD and MIMD cores in a single device.

In some examples, the computing device 100 may comprise a graphics processing unit. In one of these examples, depicted in FIG. 2B, the computing device 100 includes at least one central processing unit 121 and at least one graphics processing unit. In another of these examples, the computing device 100 includes at least one parallel processing unit and at least one graphics processing unit. In still another of these examples, the computing device 100 includes a plurality of processing units of any type, one of the plurality of processing units comprising a graphics processing unit.

In one example, a resource may be a program, an application, a document, a file, a plurality of applications, a plurality of files, an executable program file, a desktop environment, a computing environment, or other resource made available to a user of the local computing device 102. The resource may be delivered to the local computing device 102 via a plurality of access methods including, but not limited to, conventional installation directly on the local computing device 102, delivery to the local computing device 102 via a method for application streaming, delivery to the local computing device 102 of output data generated by an execution of the resource on a third computing device 106b and communicated to the local computing device 102 via a presentation layer protocol, delivery to the local computing device 102 of output data generated by an execution of the resource via a virtual machine executing on a remote computing device 106, or execution from a removable storage device connected to the local computing device 102, such as a USB device, or via a virtual machine executing on the local computing device 102 and generating output data. In some examples, the local computing device 102 transmits output data generated by the execution of the resource to another client computing device 102b.

In some examples, a user of a local computing device 102 connects to a remote computing device 106 and views a display on the local computing device 102 of a local version of a remote desktop environment, comprising a plurality of data objects, generated on the remote computing device 106. In one of these examples, at least one resource is provided to the user by the remote computing device 106 (or by a second remote computing device 106b) and displayed in the remote desktop environment. However, there may be resources that the user executes on the local computing device 102, either by choice, or due to a policy or technological requirement.

In another of these examples, the user of the local computing device 102 would prefer an integrated desktop environment providing access to all of the resources available to the user, instead of separate desktop environments for resources provided by separate machines. For example, a user may find navigating between multiple graphical displays confusing and difficult to use productively. Or, a user may wish to use the data generated by one application provided by one machine in conjunction with another resource provided by a different machine. In still another of these examples, requests for execution of a resource, windowing moves, application minimize/maximize, resizing windows, and termination of executing resources may be controlled by interacting with a remote desktop environment that integrates the display of the remote resources and of the local resources. In yet another of these examples, an application or other resource accessible via an integrated desktop environment—including those resources executed on the local computing device 102 and those executed on the remote computing device 106—is shown in a single desktop environment.

In one example, data objects from a remote computing device 106 are integrated into a desktop environment generated by the local computing device 102. In another example, the remote computing device 106 maintains the integrated desktop. In still another example, the local computing device 102 maintains the integrated desktop.

In some examples, a single remote desktop environment 204 is displayed. In one of these examples, the remote desktop environment 204 is displayed as a full-screen desktop. In other examples, a plurality of remote desktop environments 204 is displayed. In one of these examples, one or more of the remote desktop environments are displayed in non-full-screen mode on one or more display devices 124. In another of these examples, the remote desktop environments are displayed in full-screen mode on individual display devices. In still another of these examples, one or more of the remote desktop environments are displayed in full-screen mode on one or more display devices 124.

In some embodiments, the status of one or more machines 102, 106 in the network 104 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

B. Disease Knowledge Modeling

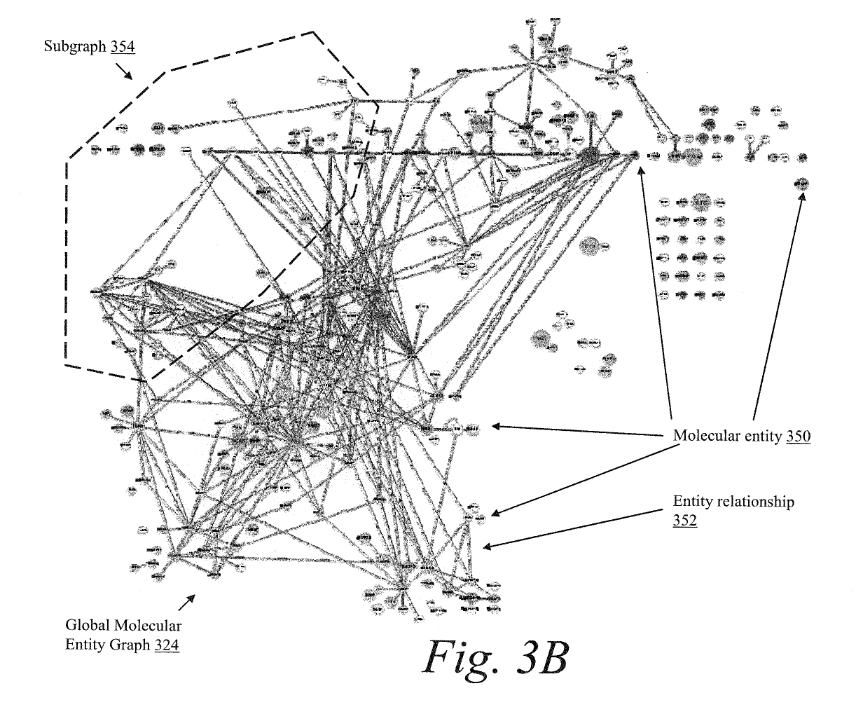

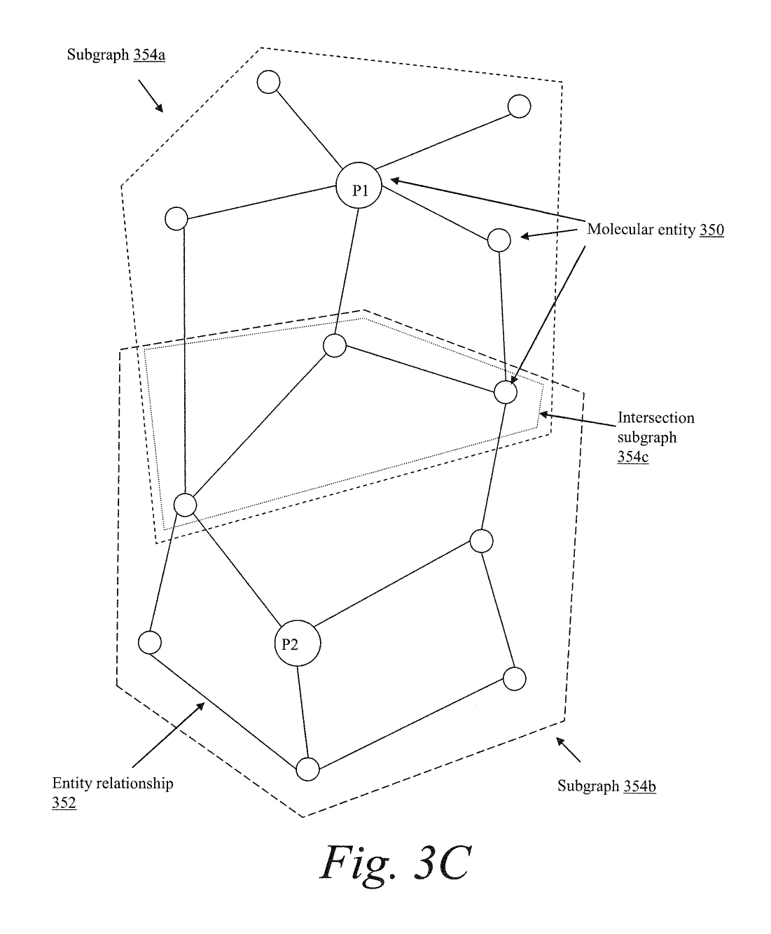

Referring now to FIG. 3A, illustrated is a block diagram of a system for disease knowledge modeling and clinical treatment decision support. In brief overview, a client 300 may comprise an application 302 and, in some embodiments, genetic information or genomic information 303. In some embodiments, a client 300 may communicate with a server 304 via any type of network, such as those discussed herein. Although shown as a separate client-server system, in many embodiments, a client 300 and server 304 may be on the same physical machine. In other embodiments, server 304 may be executed by a virtual machine provided by a cloud computing environment. For example, server 304 may comprise a hosted service or cloud service, providing scalability and ease of management. In some embodiments, a medical literature server 340 and/or an adverse event data server 342 may also communicate with a server 304. In other embodiments not shown, a second client 300 may be used to gather data from a medical literature server 340 and/or an adverse event data server 342 and processed or transferred to server 304. In some embodiments, a server 304 may comprise an input/output interface 306, a security module 308, and/or a display module 310. Server 304 may also comprise one or more databases or data stores, including an adverse event database 312, a medication information database 314, a literature database 316, and a variant database 318. Server 304 may, in some embodiments, comprise an analyzer 320 and/or a parser 322. In some embodiments, server 304 may comprise a global molecular entity graph 324.

Still referring to FIG. 3A and in more detail, in some embodiments, a client 300 may comprise a computing device of any type, such as a desktop computer, portable computer, smart phone, tablet computer, or any other type of computing device. Client 300 may execute an application 302 for accessing server 304. In some embodiments, application 302 may comprise a web browser, while in other embodiments, application 302 may comprise a dedicated application for communicating with server 304.

In some embodiments, client 300 may store, include, or otherwise access genomic information 303. Genomic information 303 may comprise genetic data about a patient. For example, in some embodiments, genomic information 303 may comprise a list of genetic variants or mutations of the patient, a full or partial genetic sequence, or any similar information. In some embodiments, genomic information 303 may be utilized for generating personalized drug efficacy or risk information or identifying potential drug interactions. Although shown on client 300, in many embodiments, genomic information 303 may be stored externally to client 300, obtained from a third party or stored on a second server or network storage device, or otherwise be supplied to server 304.

Server 304 may comprise a computing device of any type, such as a desktop computer, portable computer, rackmount server, workstation, or any other type of computing device. In some embodiments, server 304 may comprise a virtual machine executed by a cloud service, a plurality of servers forming a grid or server farm 38 and acting as a single server 304, or any other type of server. Although shown with components 306-324 as part of server 304, in many embodiments, one or more of components 306-324 may be external to server 304, on a second server (not illustrated), on an external storage device, or otherwise accessible to server 304.

In some embodiments, server 304 may execute an input/output interface 306. Input/output interface 306 may comprise an application, service, daemon, routine, or other executable logic for communicating with one or more clients 300 or other servers, medical literature servers 340, and/or adverse event data servers 342. In some embodiments, input/output interface 306 may comprise a web server or web page executed by a web server. Input/output interface 306 may provide an interface allowing a user to provide queries, make selections or identifications of drugs, indications, targets, pathways, or other molecular entities, define cohorts for analysis, or perform other functions. In some embodiments, input/output interface 306 may provide data tables, graphics, or other output views to the user. In many embodiments, input/output interface 306 may communicate via a network with application 302, while in other embodiments in which client 300 and server 304 comprise the same computing device, application 302 may be executed on server 304 and may communicate with input/output interface 306 via an API.

In some embodiments, server 304 may execute a security module 308. Security module 308 may comprise an application, service, daemon, routine, or other executable logic for receiving user credentials or login information and/or computing device credentials, such as a network address, operating system version or other identification, and processing the credentials to allow or deny access to server 304. Security module 308 may, in some embodiments, comprise a user and password database or similar features to control access to functions of server 304.

In some embodiments, server 304 may execute a display module 310. Display module 310 may comprise an application, service, daemon, routine, or other executable logic for generating graphic displays for presentation by input/output interface 306 and/or application 302 to a user. In some embodiments, display module 310 may generate graphs, tables, radial graphs, charts, biological network diagrams, or other graphical entities. In some embodiments, input/output interface 306 and display module 310 may be provided as part of a web server or application, while in other embodiments, these services may comprise separate executable modules.

Server 304 may include an adverse event database 312 and/or a medication information database 314. In some embodiments, adverse event database 312 and/or medication information database 314 may be stored on server 304, while in other embodiments, adverse event database 312 and/or medication information database 314 may be stored on a data storage server, external storage device, within a cloud storage system, or otherwise accessible to parser 322 and/or analyzer 320. An adverse event database 312 may comprise a database, flat file, data array, or other data file for storing molecular data regarding adverse events. Similarly, a medication information database 314 may comprise a database, flat file, data array, or other data file for storing molecular entity information for one or more drugs. As discussed above in connection with FIG. 1B, stored data may comprise identifications of one or more drugs 102, indications 104, reactions 106, outcomes 108, pathways 110, targets 112, metabolizing enzymes or transporters 114, and drug classes 116. In many embodiments, adverse event data may comprise demographic information of a patient, trial participant, or other person that experienced the adverse event. In many embodiments, adverse event data 102-108 from adverse event reporting systems may be combined and linked with molecular entity data 110-116 in the adverse event database 312 and/or medication information database 314. In some embodiments, molecular entity data 110-116 for a drug may be retrieved from pharmaceutical manufacturer literature, research literature or white papers, or other literature from one or more medical literature servers 340. In many embodiments, adverse event database 312 and medication information database 314 may comprise a single database, while in other embodiments, databases 312-314 may be linked to allow associations between entities and adverse event data. In some embodiments, associations may be one-to-one, such as a single outcome for a single patient, while in other embodiments, associations may be one-to-many, such as a plurality of prescribed and co-prescribed drugs for the patient, or many-to-many, such as a plurality of indications associated with each of a plurality of drugs. Accordingly, a adverse event/molecular entity database comprising adverse event database 312 and medication information database 314 may comprise a multi-dimensional database allowing associations between adverse events and biological information. Such a database may be used for novel univariate analyses, such as generating an ordered list of metabolizing enzymes most frequently associated with a specified side effect (by numbers of adverse event reports for the side effect or reaction including a drug, the drug associated with the metabolizing enzyme in medical literature). Similarly, such a database may be used for multivariate analyses, such as comparing reported side effects of all drugs targeting a first protein with side effects of all drugs targeting a second protein.

In some embodiments, medication information database 314 may comprise or be associated with a literature database 316. Literature database 316 may comprise a database, data array, flat file, or other data comprising one or more items of literature about one or molecular entities. Literature database 316 may comprise white papers, research papers, theses, dissertations, abstracts of literature, publicly available literature, proprietary manufacturer literature, research data, or other literature. In some embodiments, literature database 316 may comprise medication information, which may be extracted to generate a medication information database 314. In some embodiments, a server 304 may retrieve or receive literature from one or more medical literature servers 340. For example, in one embodiment, server 304 may retrieve abstracts or full papers from the PubMed database provided by the National Institutes of Health of Bethesda, Md. Such papers or abstracts may be parsed to identify drug names, drug classes, protein targets, metabolizing enzymes, transporters, gene variants or wild types, or other molecular entities. Once identified, the entities and associations between identified entities may be added to literature database 316, medication information database 314, adverse event database 312, or a combined multi-dimensional molecular data database.

In some embodiments, the server 304 may further comprise a literature database for identification of patient genetic variants or mutations, or may be associated with a variant database 318. A variant database may comprise a database, data file, flat file, data array, or other file comprising a full genetic sequence for one or more patients, clinical trial participants, or other persons, or may comprise a partial sequence, or may comprise an identification of one or more variants or mutated gene sequences for a patient, participant, or person. In some embodiments, a variant database may further comprise identifications of one or more proteins corresponding to a variant, in which expression or activation of the protein is affected by the mutation. For example, in one such embodiment, a database may comprise an identification of a variant and an identification of a protein activated by the wild type corresponding to the variant. By linking variant identifications, protein activation or deactivation, and drug target proteins, a user may identify potential decreased efficacy of a drug or high risk biological interactions.

In some embodiments, a server 304 may comprise an analyzer or analysis module 320. Analyzer 320 may comprise an application, service, daemon, routine, or other executable logic for performing univariate or multivariate analysis. In some embodiments, analyzer 320 may identify associated entities from a database, such as identifications of molecular entities associated with a patient indication, identifications of medications associated with molecular entities, identifications of genetic variants associated with a patient indication, reactions associated with a target protein, or outcomes associated with a genetic variant. In many embodiments, analyzer 320 may generate one or more lists of associated entities based on an input or requested first entity. Such lists may be ordered, for example, by a percentage of total associations or by number of associations in the database. Accordingly, for a query of adverse reactions associated with a first drug, analyzer 320 may return an ordered list indicating that, for example, of all reported adverse reactions associated with the first drug, nausea occurs in 60% of cases, fatigue occurs in 50% of cases, and a rash occurs in 40% of cases. Due to the possibility of patients experiencing multiple adverse events, totals may exceed 100%. Similarly, for a query of targets associated with an adverse reaction such as fatigue, analyzer 320 may return a list of molecular targets ordered by proportional reporting ratio (PRR), such as dihydroorotase having a PRR of 32.91, DNA polymerase i having a PRR of 16.45, and cytochrome b having a PRR of 8.22. Such proportional reporting rations may be determined based on a proportion of reactions to the molecular entity compared to the same proportion for all such entities in the database. Taking as an input an identification of a patient indication, the analyzer may be configured to identify and output a plurality molecular entities, in particular of proteins or genes associated with the indication having a measure of co-occurrence with the indication greater than a determined first threshold, e.g. 20%, 50% or 80%. The analyzer may also be configured to identify and output a plurality of genetic variants associated with the indication having a measure of co-occurrence with the indication greater than a determined second threshold, e.g. 20%, 50% or 80%. In some embodiments, analyzer 320 may further comprise functionality for performing multivariate analyses and comparisons. For example, analyzer 320 may comprise logic for extracting subsets of statistical data of adverse events associated experienced by an identified first cohort of patients or trial participants and an identified second cohort, and comparing the two subsets to identify adverse event differences between the cohorts. Phenotype or genotype distinctions between the cohorts may then be identified as the likely cause or mitigation of adverse events. Taking as an input identifications of a protein or gene and identifications of a genetic variant, the analyzer may be configured to identify and output the protein or gene as having a predominant measure of co-occurrence with identifications of the genetic variant and identifications of activation, repression, amplification or deletion. The analyzer may thus identify activation or repression of the gene or amplification or deletion of the protein by the genetic variant or any other molecular perturbations that modify, i.e. increase or decrease, the normal function of a gene or protein, such as amplification, deletion, changes in expression and/or epigenetic status.

In some embodiments, server 304 may comprise a parser 322. Parser 322 may comprise an application, service, daemon, routine, or other executable logic for reading and interpreting medical literature obtained from a medical literature server 340 or stored in a literature database 316. Reading and interpreting medical literature may comprise scanning literature for identifications of one or more molecular entities. Inclusion of identifications of a plurality of entities within a single item of literature may indicate an association between those entities. Such associations may then be incorporated into a medication information database 314 and/or adverse event database 312. For example, parser 322 may scan medical literature and identify that the terms “headache” and “aspirin” frequently appear in the same items of literature. Accordingly, parser 322 may identify the indication “headache” as related to the drug “aspirin” in a medication information database 314. Similarly, in some embodiments, parser 322 may identify associations within literature between drugs, targets, transporters, metabolizing enzymes, drug classes, genetic variants, side effects, indications, reactions, outcomes, patient demographic information, or any other such information. Parser 322 may scan white papers, abstracts, articles, theses, research documents, manufacturer literature, or any other type of document for associations between molecular entities. In some embodiments, parser 322 may score the identified associations responsive to one or more factors, such as frequency, proximity, and secondary citations. For example, parser 322 may give a low association score to two molecular entities that appear in only a single item of literature once. However, parser 322 may give a higher association score to the two molecular entities, if they appear in close proximity to each other within the literature, such as in the same sentence or paragraph. In some embodiments, parser 322 may give a higher association score to associations between two entities that appear in a plurality of items of literature than an association between two entities that appears repeatedly in only a single item of literature. In such embodiments, parser 322 may thus identify associations that are commonly understood by researchers, rather than unconfirmed or proposed associations. In some embodiments, parser 322 may further identify secondary items of literature that cite a first item of literature, and give a higher score to associations identified within the first item of literature. Frequently cited literature thus may become more authoritative regarding associations.

In some embodiments, server 304 may comprise a global molecular entity graph 324. Global molecular entity graph 324 may comprise a graph, database, or other data file for identifying a plurality of molecular entities and relationships between entities. Global molecular entity graph 324 may comprise a system-wide representation of some or all biological systems within the human body. For example, referring briefly to FIG. 3B, illustrated is a diagram of an example embodiment of a global molecular entity graph 324. The graph may comprise a plurality of molecular entities 350, such as proteins, enzymes, transporters, or other entities, and each entity 350 may be associated with one or more other entities 350 via a relationship 352. In some embodiments, a global molecular entity graph 324 may be used by an analyzer 320 to extract sub-graphs 354, which may comprise portions of the molecular entity graph important to a particular entity. For example, a sub-graph 354 may comprise all entities and relationships between entities associated with a first identified entity, such as a drug target. In some embodiments, multiple sub-graphs 354 may be extracted and compared to identify common entities and/or relationships between the sub-graphs. For example, referring briefly to FIG. 3C, illustrated is a diagram of an example embodiment of two extracted sub-graphs, 354a and 354b, intersected to identify an intersection sub-graph 354c. A first sub-graph 354a may be extracted for a first drug target (P1), and a second sub-graph 354b extracted for a second drug target (P2). The intersection sub-graph 354c may identify one or more molecular entities 350 affected by each of P1 and P2. These dual-affected entities may be causes of adverse effects experienced when drugs targeting P1 and P2 are taken simultaneously, but not experienced when drugs targeting P1 and P2 are taken separately.

Returning to FIG. 3A, in some embodiments the analyzer 320 is configured for identifying a plurality of molecular entities via extracting a sub-graph from a global molecular entity graph, the sub-graph comprising the plurality of molecular entities. In some embodiments, server 304 may communicate with a medical literature server 340 and/or an adverse event data server 342. Medical literature server 340 may comprise any server, database, online storage system, cloud storage device, offline storage system, computing device, or other device for storing medical literature, including research documents, theses, white papers, manufacturer data, or other literature. In some embodiments, server 304 may access medical literature server 340 to retrieve documents to fill literature database 316, medication information database 314, variant database 318, or for parsing one or more items of literature via parser 322 as discussed above. Similarly, adverse event data server 342 may comprise any server, database, online storage system, cloud storage device, offline storage system, computing device, or other device for storing adverse event data, such as the Adverse Event Reporting System provided by the U.S. Food & Drug Administration. In some embodiments, server 304 may access an adverse event data server 342 to retrieve records to fill an adverse event database 312 or for parsing by parser 322 or analysis by analyzer 320, as discussed above.

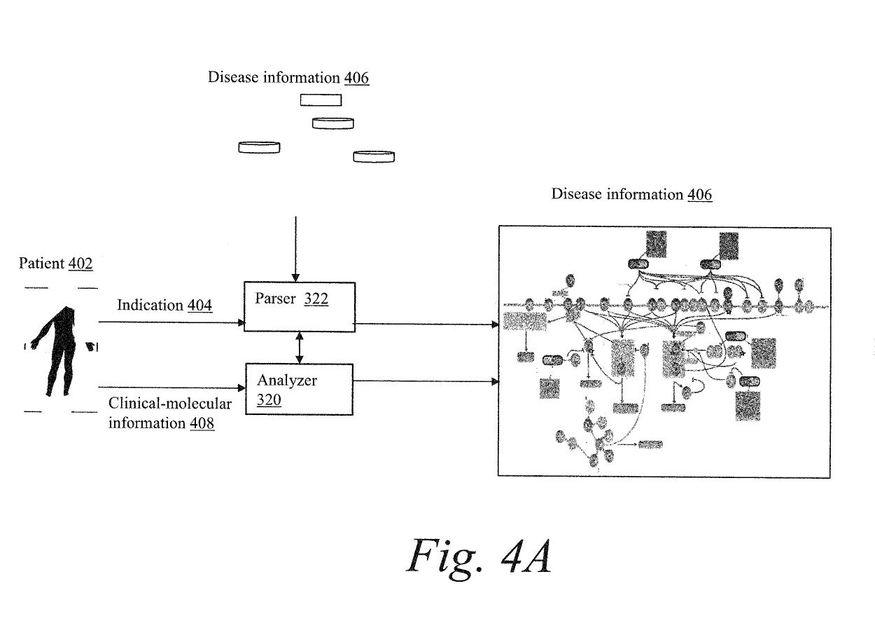

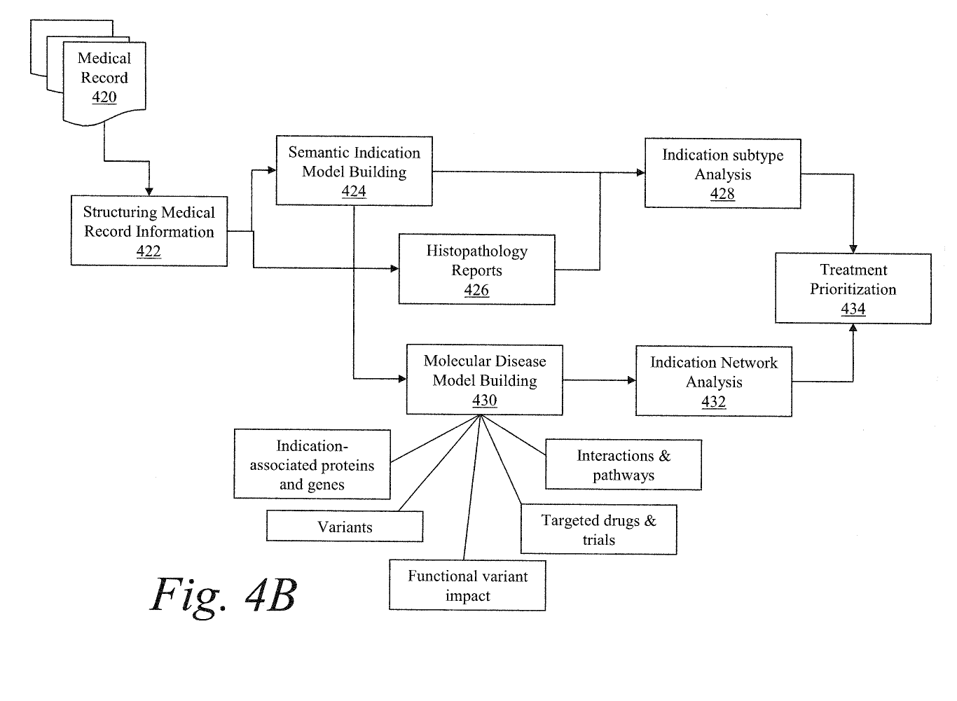

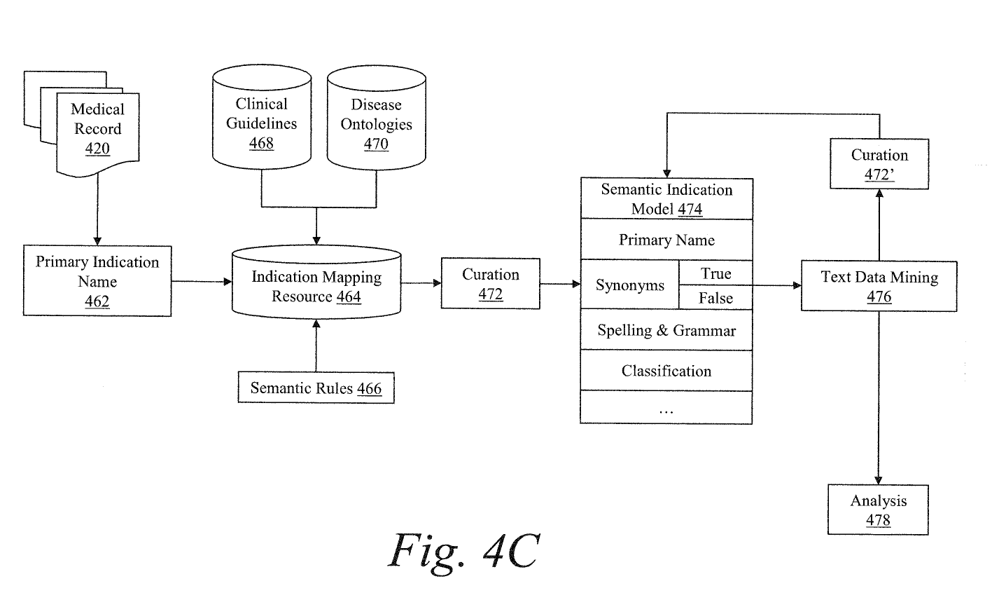

Referring now to FIG. 4A, illustrated is a block diagram of an embodiment of a system for disease knowledge modeling and clinical treatment decision support. In brief overview, information about an indication 404 of a patient 402, such as a cancer diagnosis or other disease diagnosis may be used as a search term for a parser 322, which may search available information about the indication 404 from one or more databases. Such databases may comprise, without limitation, full text journals; abstracts, such as those available on PubMed; clinical trial data; drug or medication information and target protein information, which may be provided by researchers, manufacturers, or other data sources; identifications of genes related to an indication or disease; information about pathways and interactions relevant to the disease or indication; identification of genes associated with the indication or expressing proteins associated with the indication; information regarding the standard of care of the indication, such as typical outcomes; regulatory information regarding the indication or medications associated with the indication; research reagents associated with the indication; indication information such as tumor classification and nomenclature; histology and pathology reports; or any other type and form of information. Through data mining processes, the parser 322 may identify one or more driver genes, pathways, genetic variants, drug targets, biomarkers, or other bio-molecular entities associated with the indication to build a disease information or knowledge model 406. For example, in one embodiment, parser 322 may identify a protein that appears in a large number of PubMed abstracts with the indication name as likely being associated with the indication.

Specifically, text data mining can be used to infer pairwise relations between two or more sets of entities. Exemplarily, this is briefly described on the case of exactly two sets of entities, as this is the most common case and also simplifies the explanation. If, for example, the first set of entities is a set of indications, and the second set of entities is a set of proteins, typically approximating the entire human genome, then text data mining can be used to infer which of the proteins are related to which of the indications. This is done by first counting, for each potential pair of an indication with a protein, textual entities in which both that indication and that protein occur. A textual entity may, for instance, be the full text of a published article, the abstract of a published article, any paragraph of a published article, or any sentence of a published article. Then, this co-occurrence frequency may be combined with other data to compute a measure of co-occurrence. Such other data may be, for instance, background frequencies of single entities. In the simplest case, this measure is merely identical to the count. Finally, the measure is compared to a threshold in order to decide whether to postulate an association between the two entities, e.g. indication and protein, or not.

In some embodiments, an analyzer 320 such as an analyzer executed by a multivariate analysis system may receive clinical-molecular information about the patient 402, such as patient-specific genetic variants identified via mapping of the patient's genome, identification of medications prescribed to the patient, or other information. In particular, clinical-molecular information about the patient may be retrieved via text mining, namely from textual data in electronic medical records. Analyzer 320 may use the knowledge model 406 to make evidence-based treatment decisions, such as prioritizing a list of medications to be prescribed to the patient for the indication, identifying potential combination therapies indicated or contraindicated for the patient, etc. For example, in some embodiments discussed in more detail below, analysis of knowledge model 406 may identify a plurality of protein targets associated with the indication, and analyzer 320 may identify, from a medication information database or similar data source, one or more medications affecting activity of the plurality of protein targets. Such medications may be prioritized higher than medications that affect activity of only one protein target, or no protein targets associated with the indication, for example. Analyzer 320 may thus comprise an application, service, daemon, routine, or other executable logic for generating a prioritized list of suggested treatments, each comprising one or more of the plurality of medications. Analyzer 320 may order the suggested treatments according to a priority measure. Such priority measures may be computed as a score for each treatment, the score for instance comprising a count or a weighted count of the molecular entities affected by the one or more medications of the suggested treatment or of the medications comprised in the suggested treatment. Further, analyzer 320 may contain code to prioritize suggested treatments depending on properties of one or more medications of the suggested treatment, such as properties of the one or more identified molecular entities associated with the medications or any information about stages of development of the one or more medications of the suggested treatment.

Referring now to FIG. 4B, illustrated is a block diagram of an embodiment of a method for analysis of disease information for disease knowledge modeling. In brief overview, one or more patient histories, adverse event records, prescription load information, or similar medical records 420 may be analyzed and combined to generate structured medical record information 422 for the patient or indication. This may comprise normalizing the records, correcting misspellings, abbreviations, typographical errors, or otherwise preparing the records for being combined in a parseable structure for automated analysis. In one embodiment, structuring the medical record information may comprise identifying events that occur during treatment of an indication, such as the onset of symptoms, dates of surgeries, dates of radiation therapy, diagnosis of recurrences, checkups, meetings of a hospital tumor board, pathology or other tests, etc. Information may include identification of further documentation, site within the patient (which may be relevant for cancer indications or similar diseases), dates, test results, medications prescribed, adverse events, or other information.

Collecting the sparse information about rare disease entities may frequently involve text data mining approaches. Thus, at step 424, in some embodiments, the analyzer may build a semantic indication model, or a precisely defined semantic framework for the indication to facilitate text data mining. For example, referring briefly ahead to FIG. 4C, illustrated is a block diagram of an embodiment of a system for building a semantic indication model 424. A primary indication name 462 may be identified in patient medical records 420, and used as an input to an indication mapping resource 464. Indication mapping resource 464 may comprise an application, server, service, daemon, or other executable logic for retrieving clinical guidelines 468 and disease ontologies 470 corresponding to an identified indication 462 from databases or storage devices, and applying one or more semantic rules 466 to create a unified semantic model of the indication. For example, the World Health Organization classifies the rare and invasive malignant peripheral nerve sheath tumor (MPNST) as a “tumor of the central nervous system,” distinct from, but related to schwannoma, neurofibroma, and peurineurioma, based on MPNST's association with neuroectodermal, central nervous system-derived structures. By contrast, the National Comprehensive Cancer Network (NCCN) classifies MPNST as a “soft tissue sarcoma” (STS) of mesenchymal origin, based on gene-expression based indication clustering. Accordingly, a system that can identify and integrate records relating to each classification can facilitate a richer understanding of the indication than one that views the WHO and NCCN classifications as distinct and unrelated. The indication mapping resource may be used to identify true indication synonyms, such as abbreviations compared to full names; closely related indications (e.g. malignant schwannoma); distantly related indications (e.g. synovial sarcoma); and indication superfamilies (e.g. soft tissue sarcoma or STS). In some embodiments, an administrator or researcher may perform curation 472 on the indication mapping, to prevent false positive or negative correlations between terms. The knowledge model building system may then generate a semantic indication model 474, identifying the indication name 462, synonyms for the indication, alternate spellings, classifications, or any other data relevant to the indication. Through further text data mining 476 of available literature, such as PubMed abstracts, drug manufacturer information, clinical trial publications, or any other data, additional information about the indication may be retrieved and added to the semantic indication model 474, including identification of relevant or important bio-molecular entities, pathways, or related systems. In some embodiments, the retrieved data may be further curated 472′ to identify false positives or negatives. The semantic indication model 474 may then be used for further analysis 478 for prioritizing therapies.

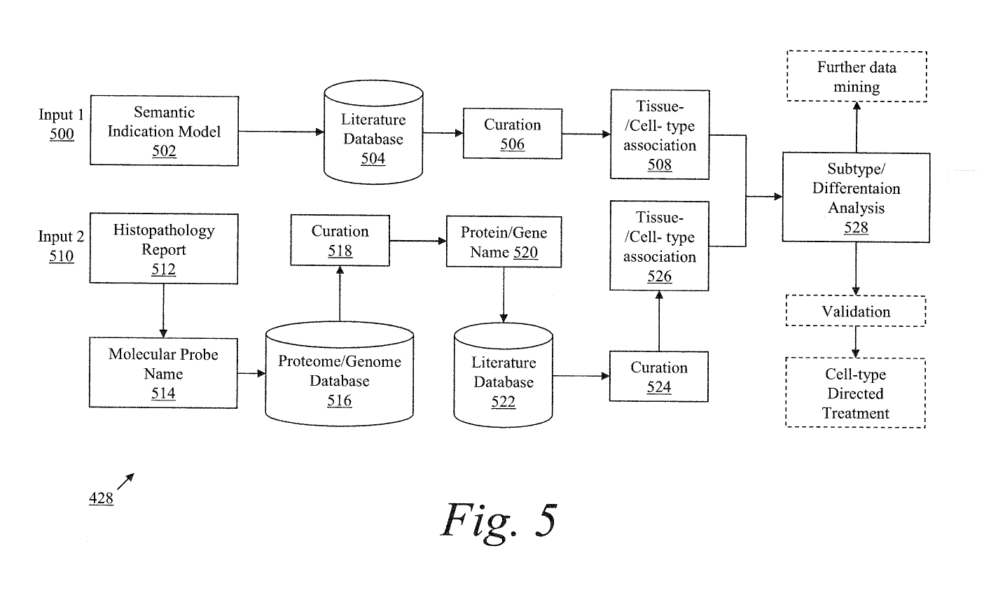

Returning to FIG. 4B, in some embodiments, the semantic indication model 424 may be provided for indication subtype analysis 428. For example, given the cancer type MPNST, various phenotypic differentiation patterns may occur, including rhabdomyoblastic, perineurial, angiosarcomic, glial, cartilaginous, or others. Thus, although classified as a single tumor type, MPNSTs may have diverse histogenetic origins, reflecting the tissue- and cell composition of the peripheral nerve sheath. Accordingly, it may be valuable to further analysis and classify relevant indication subtypes when prioritizing treatment decisions. Referring now to FIG. 5, illustrated is a block diagram of an embodiment of a system for utilizing semantic indication models and histopathology reports for differentiation analysis 428 of a disease knowledge model. In brief overview, the semantic indication model 502 may be used as a first input 500 and a histopathology report of the patient 412 may be used as a second input 510 for differential analysis. The model 502 may be used to retrieve information from a literature database 504, as discussed above. For example, the model 502 may provide keywords for searching within literature for additional information, associated bio-molecular entities, or other associations. As discussed above, at 506, in many embodiments, an administrator, user, or researcher may curate the retrieved data to remove false positives or negatives. At 508, the analyzer may determine a tissue- or cell-type association for the indication based off of the retrieved literature.

Similarly, with input 2, patient histopathology 512 may be parsed to identify all molecular probe information 514 for mapping to unified human gene/protein names 516, which, in some embodiments, may be curated 518 to remove any false positives or negatives. For each identified protein/gene name 520, a literature database 522 may be parsed to identify cell-type or tissue-type expression information 526. In many embodiments, steps 522-526 may be similar to steps 504-508, with different inputs based on histopathology report 512 as opposed to semantic indication model 502. Differences between the outputs 508, 526 given the two inputs may be determined and analyzed at 528, and may be used for further data mining or for directed treatment and prioritization, as shown in step 434 of FIG. 4B.

Referring back to FIG. 4B, given the semantic indication model produced at 424, a molecular disease model may be built from information regarding indication-associated proteins and targets; genetic variants, including identification of functional impacts of variants such as activation or inactivation of a protein; targeted drugs and clinical trials; and interactions with pathways and other molecular entities. As discussed above, this information may be mined from relevant literature, as well as extracted from a global molecular entity graph, to generate a network of entities associated with the indication 432. This network may be analyzed to identify targets most likely to be associated with the indication, such as targets highly interconnected within the network or targets closely associated with the organ affected by the indication.

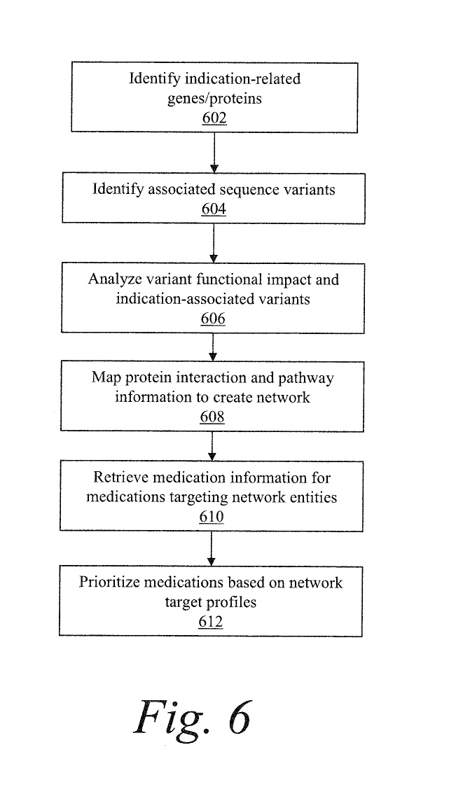

Referring now to FIG. 6, illustrated is a flow diagram of an embodiment of a method for prioritizing treatment decisions. In brief overview, at step 602, an analyzer module executed by a multivariate analysis system may identify indication related genes or proteins for a specified patient indication. The specified patient indication may be retrieved by the analyzer from a database, may be selected by a user or physician, or otherwise entered. At step 604, the analyzer may identify genomic or genetic sequence variants associated with the indication. At step 606, the analyzer may determine variant functional impact and indication-associated variants, and may select a subset of the plurality of proteins or genes responsive to the identified functional impact of the genetic variant on the protein or gene associated with the patient identification. At step 608, the analyzer may map protein interaction and pathway information to create an indication-specific molecular entity network. At step 610, the analyzer may retrieve, from a medication information database, medication information for medications targeting network entities in the indication-specific network. At step 612, the analyzer may prioritize medications based on network target profiles or generate a prioritized list of suggested treatments, each comprising one or more of the medications. The priority of each suggested treatment may be based on least one property of the one or more medications of the suggested treatment.

Still referring to FIG. 6 and in more detail, at step 602, an analyzer executed by a multivariate analysis system, such as those discussed above, may identify indication-related genes or proteins for a specified patient indication. In some embodiments, the analyzer may receive an identification of the indication from a user. In other embodiments, the analyzer may retrieve the identification of the indication from another computing device or storage device. The analyzer may perform text mining and statistical analysis of literature to find and prioritize genes and protein terms identified in documents associated with the indication, typically by a measure of co-occurrence. The documents may comprise medication information, clinical trial information, PubMed abstracts, white papers, research papers, thesis papers, adverse event data or records, or any other type and form of documents. In many embodiments, the analyzer may identify all molecular entities studied in the disease-context, irrespective of a causative contribution, thus including histological markers, general indication markers, indication-specific markers, indication-specific gene candidates, known associated proteins or pathways, or any other entities. In many embodiments, the identified molecular entities may include factors involved in indication-related tissue and cell biology, known or currently assumed disease genes and proteins, candidate drivers of various forms of the indication, and entities that have been merely suggested to be causally involved.

At step 604, the analyzer may identify genetic sequence variants associated with the indication. In some embodiments, similar to step 602, the analyzer may parse literature for a measure of -occurrence analysis of genetic variants identified in documents associated with the indication. This may allow for identification of candidate disease genes, including drivers of the indication, passengers or correlated genes that may lack a direct causal link, or structural genomic aberrations indicative of or involved in the indication.

At step 606, the analyzer may determine variant functional impact and indication-associated variants. In some embodiments, the analyzer may identify gene ‘activation’ or ‘amplification,’ or ‘repression’ or ‘deletion’ associated with the identified variants, and a mechanistic contribution to the indication. For example, variants that cause inactivation of a protein and a causal link between deactivation of the protein and the indication may be identified. In some embodiments, the analyzer may identify this impact via literature, while in other embodiments, the analyzer may parse a global molecular entity graph or sub-graph associated with the indication and identify proteins relevant to the indication with functions affected by the identified genetic mutation. In some embodiments, the genes identified to have a mechanistic contribution to the indication may be selected as a core entity set for the molecular disease model. The analyzer may select a subset of the indication-related genes or proteins responsive to the identified functional impact of the genetic variant on the protein or gene.

At step 608, in some embodiments, the analyzer may map protein interaction and pathway information to create or generate an indication-specific molecular entity network. As discussed above, the analyzer may extract a sub-graph from a global molecular entity graph or may generate a subnetwork from a global molecular entity array comprising the identified core entity set. Protein-protein interactions, molecular pathway information, or other relevant information may be used to construct a network model associated with the indication. This may allow for identification of potential epistatic effects of drug targets and variants. In some embodiments, where pathways or indication relevant cellular processes are known, the analyzer may add molecular mediators, effectors, or paralogous proteins to the model.

At step 610, the analyzer may retrieve, from a medication information database, medication information for medications targeting network entities in the indication-specific network. In some embodiments, the analyzer may search a medication information database for medications that are associated with or mapped to targets identified in the indication-specific network. The identified medications may be prioritized according to stage and indication of development, for example, using the synonyms and classification of the indication within the semantic indication model. In some embodiments, the medication information database may be augmented through retrieval of information about medications under development or testing, or in clinical trials related to the indication or similar indications.

At step 612, the analyzer may prioritize medications based on network target profiles. In one embodiment, medications identified at step 610 may be mapped against their targets in a phylogenetic tree of molecular entities, such as protein tyrosine kinases or similar elements associated with the indication. In some embodiments, medications that target a plurality of entities associated with the indication may be prioritized higher than medications that target only one entity. In other embodiments, a set of medications may be selected for combination therapy based on non-overlapping target profiles between the medications, with the combination targeting a high number of indication-specific amplified or over-expressed proteins or genes.

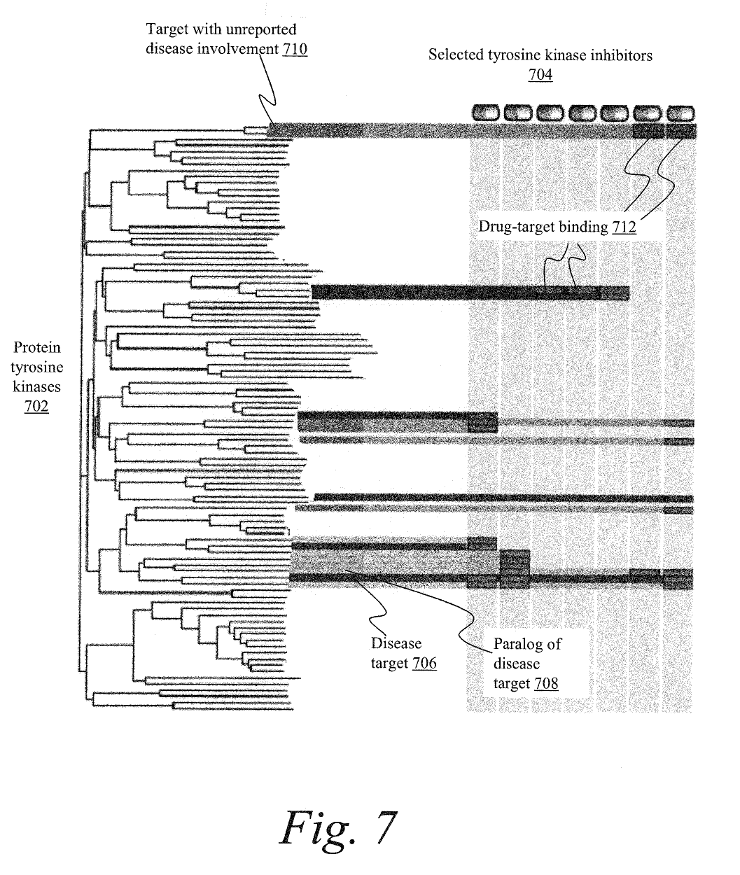

For example, referring to FIG. 7, illustrated is a tree diagram of an exemplary disease model and prioritized medication information. As shown, a phylogenetic tree 702 of protein tyrosine kinases and their relationships may be provided with medications 704 identified by their target bindings 712 to relevant disease targets 706, paralogs of disease targets 708, and/or targets with unreported disease involvement 710 identified from the indication sub-network, associations in published literature, multivariate analysis of adverse event data, or other means. Medications may be selected and prioritized such that the largest number of targets 706-710 are affected with the fewest number of medications. Further priority measures may be computed as a score for a treatment, the score comprising a count or a weighted count of the molecular entities affected by the one or more medications of the treatment or of the medications comprised in the treatment. A treatment may further be prioritized depending on properties of the one or more identified molecular entities associated with the medications or depending on any information about stages of development of the one or more medications of the suggested treatment. For example, given four targets, a medication targeting all four would have a higher priority than a medication targeting just one. Similarly, a combination of a medication targeting the first two targets and a second medication targeting the second two targets may be prioritized over a combination of four medications each targeting one target.

The rapid advancement of high-throughput technologies available for generating large-scale molecular-level measurements in human populations has led to an increased interest in the discovery and validation of molecular biomarkers in clinical research. Biomarkers are generally defined as any “biological characteristic that is objectively measured and evaluated as an indicator of normal biologic processes, pathogenic processes, or pharmacologic responses to a therapeutic intervention”. Various types of biomarkers may include genomic biomarkers (e.g. single nucleotide variations (SNV), copy number variations (CNV), insertions, deletions, gene fusions, polyploidy, gene expression, miRNA's), proteomic biomarkers (e.g. post-translational modifications, expression), metabolites, electrolytes, physiological parameters (e.g. blood pressure), patient age, patient weight, or patient co-morbidities. Uses of biomarkers for clinical decision making is quite varied and includes identification of predictive and prognostic factors for disease management, surrogate endpoints for monitoring clinical response to an intervention and early detection of disease.

### Detection of Tumor-Specific Genomic Variants

In some implementations, the system allows for a fully automated workflow/pipeline for the detection of tumor-specific (somatic) non-synonymous single nucleotide variants (SNVs) in tumor-normal paired exome sequencing data sets. Variant detection occurs in a two-step process: (1) sequence alignment and (2) variant calling. The first step involves the global optimal alignment of sequence reads to the most current assembly of the human genome. Sequence reads can be de-duplicated prior to this step in some implementations.

In the second step the alignments from the tumor-normal paired sequence data set are used to call genomic sequence variants. Based on pre-set cut-off values for variant calling metrics, the set of detected tumor-specific genomic variants may be further processed for prioritization via ‘functional impact scoring’ or scoring of importance of a variant to an indication or tumor, discussed in more detail below.

### Relating Genomic Variants to Reference Genes/Proteins

In some embodiments, the system may map all detected genomic variants unambiguously to reference proteins. This allows the prioritization of genomic variants based on any protein-centric information, e.g. the collective cancer or indication-relevant attributes of the affected protein. In addition, the mapping supports the precise association of genomic variants with sequence-position-based structural-functional features and annotations of proteins. This association may be used to determine the known or predicted impact of the precise mutation on the generic biological activity/function of the protein (referred to ‘functional impact scoring’).

### Prioritizing Cancer-Relevant Genes/Proteins in an Indication Specific Manner.

In some implementations, the system collates clinically relevant information for the complete human proteome across various knowledge domains and, in some embodiments, is specifically tailored to oncology. In addition to capturing oncology-wide knowledge across all cancer types, for example, it may use specific indication information from the patient under analysis. The collated information is used to compute a score for each protein, which directly reflects its importance for cancer in general and the cancer type under consideration. Similar steps may be applied for other indications or subtypes Importantly, this relevancy score rates the cancer or indication-relevance of a protein independent of the occurrence of a genomic variant in the protein in a concrete patient case.

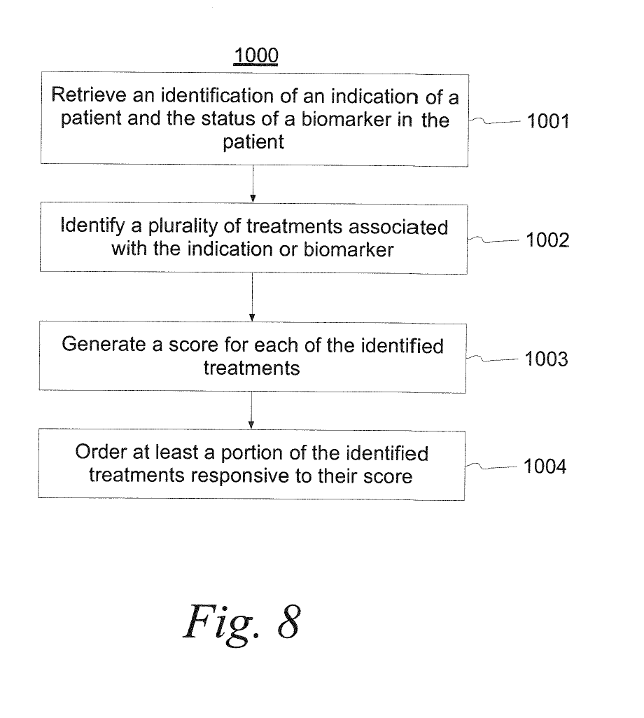

FIG. 8 is a flow chart illustrating a method 1000 for delivering clinical decision support according to one exemplary embodiment. In general, the analysis module retrieves an identification of an indication of a patient and the status of a biomarker in a patient (step 1001). The analysis module then identifies a plurality of treatments associated with the biomarker or indication (step 1002). Responsive to identifying the treatments, the analysis module generates a score for each of identified treatments (step 1003). Then the possible treatment options are prioritized and displayed to a user (step 1004).

In summary, computational disease knowledge modeling may be used to provide evidence-based treatment prioritization for indications, particularly rare or poorly understood indications. Computational data mining can additionally aid in aggregating important up-to-date information on standard of care and assist indication subtype analysis.

While the invention is particularly shown and described with reference to specific embodiments, it should be understood by those skilled in the art that various changes in form and detail may be made therein without departing from scope of the invention as defined in the claims.

1. A method for prioritizing treatment decisions, comprising:
retrieving, by an analyzer executed by a processor of a computing device, an identification of a patient indication;
identifying, by the analyzer, one or more molecular entities associated with the patient indication;
retrieving, by the analyzer from a medication information database, a plurality of identifications of medications associated with one or more identified molecular entities; and
generating, by the analyzer, a prioritized list of suggested treatments, each comprising one or more of the plurality of medications, wherein the priority of a suggested treatment depends on at least one property of one or more medications of the suggested treatment.

2. The method of claim 1, wherein generating the prioritized list of suggested treatments comprises computing a score for each treatment and sorting the treatments according to the score.

3. The method of claim 2, wherein the score comprises a count or a weighted count of the molecular entities affected by the one or more medications of the suggested treatment.

4. The method of claim 2, wherein the score comprises a count or a weighted count of the medications comprised in the suggested treatment.

5. The method of claim 1, wherein generating the prioritized list of suggested treatments comprises ordering the suggested treatments in order from fewest medications comprised in the suggested treatment to most.

6. The method of claim 1, wherein a property of the one or more medications of the suggested treatment is a property of the one or more identified molecular entities associated with the medications.

7. The method of claim 1, wherein a property of the one or more medications of the suggested treatment is a stage of development of the one or more medications of the suggested treatment.

8. The method of claim 1, wherein identifying one or more molecular entities associated with the patient indication comprises searching a literature database for identifications of a molecular entity having a measure of co-occurance with identifications of the patient indication greater than a first threshold.

9. The method of claim 1, further comprising identifying at least one genetic variant associated with the patient indication.

10. The method of claim 9, wherein identifying at least one genetic variant associated with the patient indication comprises searching a literature database for identifications of a genetic variant having a measure of co-occurance with identifications of the patient indication greater than a second threshold.

11. The method of claim 9, wherein identifying one or more molecular entities associated with the patient indication further comprises identifying activation or repression of a gene or of a protein by the genetic variant or other molecular perturbations caused by the genetic variant that modify the function of a gene or protein, and selecting said gene or protein for inclusion in the one or more identified molecular entities.

12. The method of claim 11, wherein identifying activation or repression of a gene or of a protein by the genetic variant or other molecular perturbations caused by the genetic variant that modify the function of a gene or protein, comprises searching a literature database for identifications of the protein or gene and/or the genetic variant having a measure of co-occurrence with identifications of molecular perturbations and/or identifications of activation, repression, amplification, deletion and/or change.

13. The method of claim 1, wherein identifying one or more molecular entities comprises extracting a sub-graph from a global molecular entity graph, the sub-graph comprising the one or more molecular entities.

14. A system for prioritizing treatment decisions, comprising:
a computing device comprising a processor and a memory, the processor executing an analyzer configured for:
retrieving an identification of a patient indication;
identifying one or more molecular entities associated with the patient indication;
retrieving, from a medication information database, a plurality of identifications of medications associated with one or more identified molecular entities; and
generating a prioritized list of suggested treatments, each comprising one or more of the plurality of medications, wherein the priority of a suggested treatment depends on at least one property of the one or more medications of the suggested treatment.

15. The system of claim 14, wherein the analyzer is further configured for searching a literature database for identifications of a molecular entity having a measure of co-occurance with identifications of the patient indication greater than a first threshold.

16. The system of claim 14, wherein the analyzer is further configured for identifying at least one genetic variant associated with the patient indication.

17. The system of claim 16, wherein the analyzer is further configured for identifying activation or repression of a gene or of a protein by the genetic variant or other molecular perturbations caused by the genetic variant that modify the function of a gene or protein, and selecting said gene or protein for inclusion in the one or more identified molecular entities.

18. The system of claim 17, wherein the analyzer is further configured for searching a literature database for identifications of the protein or gene and/or genetic variant having a measure of co-occurrence with identifications of molecular perturbations and/or identifications of activation, repression, amplification, deletion, and/or change.

19. The system of claim 14, wherein the analyzer is further configured for extracting a sub-graph from a global molecular entity graph, the sub-graph comprising the selected subset of the one or more identified molecular entities.
